(19) United States
(12) Patent Application Publication
(10) Pub. No.: US 2010/0147102 A1
(43) Pub. Date: Jun. 17, 2010

(54) Rap N' Ride

(76) Inventors: Nora Egan, Long Beach, NY (US); Lisa Ignatow, New York, NY (US)

Correspondence Address: Susan C. Warnock, Esq., 880 Third Avenue - 13th Floor, New York, NY, 10022, US

(21) Appl. No.: 12/629,024

(22) Filed: Dec. 1, 2009

Related U.S. Application Data
(60) Provisional application No. 61/122,871, filed on Dec. 16, 2008.

(51) Int. Cl. B62K 21/26

(52) U.S. Cl. 74/551.9

(57) ABSTRACT

The Rap N' Ride is designed to absorb perspiration from the hands of a rider who is exercising on a stationary bike. The Rap N' Ride protects the rider's hands from perspiration residue left on the bike's handlebars by previous riders and minimizes slippage when riders change hand position on the handlebars.

### CROSS REFERENCE TO RELATED APPLICATIONS

This non-provisional patent application cross references Application No. 61/122,871—a provisional application filed 16 Dec. 2008 for the same invention.

### STATEMENT REGARDING FEDERALLY SPONSORED RESEARCH OR DEVELOPMENT

None.

### REFERENCE TO MICROFICHE APPENDIX

None

### BACKGROUND OF INVENTION

When exercising on a stationary exercise bicycle—particularly those designed for group exercise—there is a safety and hygiene hazard posed by perspiration build up on the handlebars of the bike. The handlebars of stationary exercise bicycles do not absorb perspiration from the rider's hands. Consequently, slippage can occur when the rider changes his or her hand position. In addition, riders are often exposed to perspiration residue from other riders.

### BRIEF SUMMARY OF INVENTION

The Rap N' Ride is designed to absorb perspiration from the hands of a rider who is exercising on a stationary bike. The Rap N' Ride protects the rider's hands from perspiration residue left on the bike's handlebars by previous riders and minimizes slippage when riders change hand position on the handlebars.

### Description of Drawings

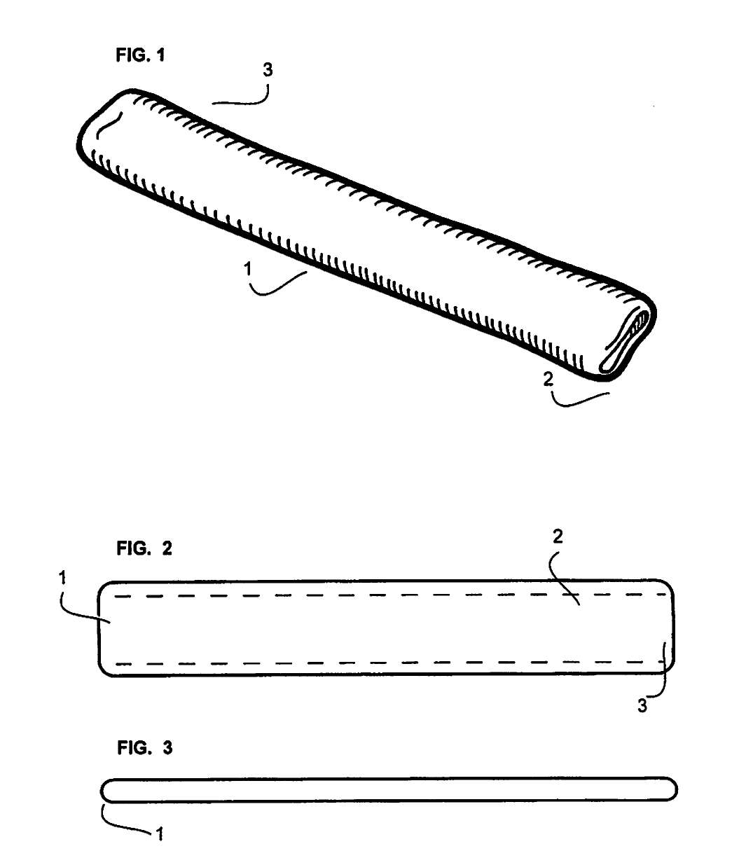

FIG. 1—Perspective View
(1)—15¾ inches
(2)—Opening
(3)—Closed Opening

FIG. 2—Plan View
(1)—¼ inch stitched seam
(2)—2 inches
(3)—Opening

FIG. 3—Elevation View
(1)—¼ inch thick

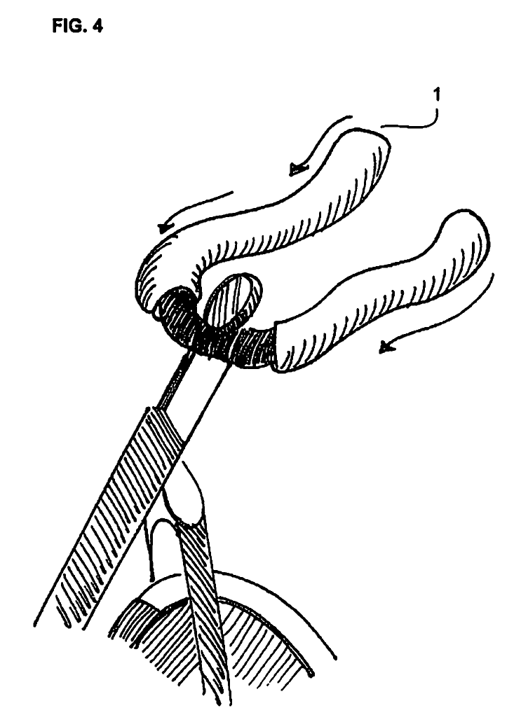

FIG. 4
(1)—Pair slips on handlebars

### DETAILED DESCRIPTION OF INVENTION

The Rap N' Ride is a pair of cloth cylinders designed to absorb perspiration from the hands of a rider who is exercising on a stationary bike. The Rap N' Ride protects the rider's hands from perspiration residue left on the bike's handlebars by previous riders and minimizes slippage when riders change hand positions on the handlebars. Perspiration is absorbed by the cloth.

The Rap N' Ride is convenient to transport and easy to use. The Rap N' Ride is washable and environmentally friendly.

The Rap N' Ride securely rolls onto the handlebars of a stationary bike holding its form and position. The Rap N' Ride offers both a solution for hygiene in that it protects the rider's hands from perspiration residue left by previous riders; and rider safety—in that it minimizes slippage when riders change their hand positions.

With the Rap N' Ride we hope to eradicate the hygiene and safety hazard posed by perspiration residue on the handlebars of the stationary exercise bicycle—particularly on those bicycles that are used for group exercise.

The embodiments of the invention in which an exclusive property or privilege is claimed are defined as follows:

1. A device which creates a barrier between the handlebars of a stationary exercise bicycle and the rider's hands comprised of a pair of cloth cylinders that roll onto the handlebars.

2. The device of claim 1 such that when the device is rolled onto the handlebars of a stationary exercise bicycle, perspiration from the rider's hands is absorbed.

3. The device of claim 1 such that when the device is rolled onto the handlebars of a stationary exercise bicycle, perspiration from the rider's hands is absorbed and the rider's hands will not slip.

4. The device of claim 1 such that when the device is rolled onto the handlebars of a stationary exercise bicycle, the device will protect the rider's hands from perspiration residue left by prior riders.
